(19) United States
(12) Patent Application Publication
(10) Pub. No.: US 2013/0318876 A1
(43) Pub. Date: Dec. 5, 2013

(54) METHOD OF FIXING DRIVE MOTOR IN WINDOW REGULATOR AND WINDOW REGULATOR

(71) Applicant: Yachiyo Industry Co., Ltd., Sayama-shi (JP)

(72) Inventors: So Takakura, Sakura-shi (JP); Tatsuaki Uehara, Sakura-shi (JP)

(21) Appl. No.: 13/908,417

(22) Filed: Jun. 3, 2013

(30) Foreign Application Priority Data
Jun. 4, 2012 (JP) 2012-126728

(51) Int. Cl. E05F 15/16; E05F 11/38

(52) U.S. Cl. CPC E05F 15/1692; E05F 11/385
USPC 49/349; 49/506

(57) ABSTRACT

A method of fixing a drive motor in a window regulator is provided which enables mounting operations to be facilitated. The window regulator includes the drive motor, an elongate push-pull member, and a frame. The frame has a guide portion for guiding the elongate push-pull member, a motor-fixture portion for mounting the drive motor, a motor mounting hole, and a positioning regulating portion for positioning the drive motor. The method includes the steps of: mounting the drive motor on the motor-fixture portion; rotating the drive motor with an output shaft of the drive motor as a center of rotation to bring a portion of the drive motor into contact with the positioning regulating portion; and connecting the drive motor with the frame through the motor mounting hole.

### BACKGROUND OF THE INVENTION

1. Field of the Invention

The present invention relates to a method of fixing a drive motor in a window regulator which causes a pane of window glass of an automobile to move up and down, and also relates to a window regulator. 2. Description of Related Art

Japanese Utility Model Laid-open Publication No. S60-68284 discloses a window regulator having a rack belt and a drive gear. In this conventional window regulator, the drive gear is connected with a drive motor, and the rack belt is open ended and flexible, meshes with the drive gear, and can be pushed and pulled by bidirectional rotations of the drive gear. The above conventional window regulator further has a rack guide, which guides the rack belt. An end of the rack belt is connected with a window, and the window regulator is configured in such a manner that the window moves up and down by conversion of the torque of the drive gear to a linear motive force.

However, in conventional window regulators, the drive motor, the rack belt, the rack guide, and the like are fixed to the side door in separate steps. This requires complicated operations of positioning and mounting the components.

The present invention has been made for solving the above problem, and an object of the present invention is to provide a method of fixing a drive motor in a window regulator, and also a window regulator, which enable mounting operations to be facilitated.

### SUMMARY OF THE INVENTION

In order to achieve the above object, one aspect of the present invention provides a method of fixing a drive motor in a window regulator. The window regulator includes a drive gear connected with the drive motor, an elongate push-pull member which is open ended, meshes with the drive gear, and is moved by bidirectional rotations of the drive gear to ascend and descend a carrier, and a frame for fixing and supporting the drive motor. The frame has a guide portion for guiding the movement of the elongate push-pull member, a motor-fixture portion for mounting the drive motor, a motor mounting hole formed in the motor-fixture portion, and a positioning regulating portion formed on the motor-fixture portion for positioning the drive motor. The method includes the steps of mounting the drive motor onto the motor-fixture portion, rotating the drive motor with an output shaft as a center of rotation to bring a portion of the drive motor into contact with the positioning regulating portion, and connecting the frame with the drive motor through the motor mounting hole.

According the above method, the frame includes the motor fixture portion for holding the drive motor and also includes the guide portion for guiding the elongate push-pull member. Accordingly, operations to mount the drive motor and the elongate push-pull member onto the frame are facilitated. Further, by bringing the portion of the drive motor into contact with the positioning regulating portion formed on the frame, positioning of the drive motor relative to the frame is facilitated, so that the mounting operations are further facilitated. In addition, since the frame is assembled to make the window regulator in advance, operations to fix the window regulator to a side door are facilitated.

Another aspect of the present invention is to provide a window regulator. The window regulator includes a drive gear connected with a drive motor, an elongate push-pull member which is open ended, meshes with the drive gear, and is moved by bidirectional rotations of the drive gear to ascend and descend a carrier, and a frame for fixing and supporting the drive motor. The frame has a guide portion for guiding motion of the elongate push-pull member, a motor-fixture portion for mounting the drive motor, a motor mounting hole formed in the motor-fixture portion, and a positioning regulating portion formed on the motor-fixture portion and contacting a portion of the drive motor. The positioning regulating portion includes a side wall and a cover. The side wall is provided upright on the motor-fixture portion. The cover extends from the side wall and covers a portion of the motor-fixture portion. The portion of the drive motor enters a space defined by the side wall and the cover in a circumferential direction of an output shaft of the drive motor. In addition, since the frame is assembled to make the window regulator in advance, operations to fix the window regulator to a side door are facilitated.

With the above configuration, the frame includes the motor fixture portion for holding the drive motor and a guide portion for guiding the elongate push-pull member. Accordingly, operations to mount the drive motor and the elongate push-pull member onto the frame are facilitated. Further, by rotating the drive motor to bring the portion of the drive motor into contact with the positioning regulating portion formed on the frame, positioning the drive motor relative to the frame is facilitated, so that the mounting operations are further facilitated.

Preferably, the window regulator has a height, from the motor-fixture portion to the cover, which is approximately equal to a thickness of the portion of the drive motor that contacts the positioning regulating portion.

With the above configuration, since the portion of the drive motor is sandwiched between the motor fixture portion and the cover, the positioning of the drive motor is stabilized.

According to the window regulator of the present invention, mounting operations are facilitated.

### BRIEF DESCRIPTION OF THE DRAWINGS

FIG. 1 is a perspective exterior view illustrating an embodiment in which a window regulator according to the present invention is applied to a side door in an automobile.

FIG. 2 is a schematic side view illustrating a drive path and an idle path of the elongate push-pull member.

FIG. 3 is a perspective exterior view illustrating a window regulator according to the present invention.

FIG. 4 is an exploded perspective view of the part B in FIG. 3, showing details of the part B.

FIG. 5A is a cross-sectional view at the I-I cross section indicated in FIG. 3.

FIG. 5B is a cross-sectional view at the J-J cross section indicated in FIG. 5A.

FIG. 6 is a view showing a preparation step in a method of fixing a drive motor according to the present invention.

FIG. 7 is a view showing a mounting step and a rotation step in a method of fixing a drive motor according to the present invention.

FIG. 8 is a view showing a window regulator in which a drive motor is fixed to a frame.

### DETAILED DESCRIPTION OF THE EMBODIMENT

Hereinbelow, an embodiment in which a window regulator is applied to a side door in an automobile is explained. In the following explanations, the direction along a plate surface of a pane of window glass in a plan view (i.e., the front-rear direction of the automobile) is denoted by the P direction, and the direction approximately perpendicular to the plate surface of the window glass (i.e., the width direction of the automobile) is denoted by the Q direction.

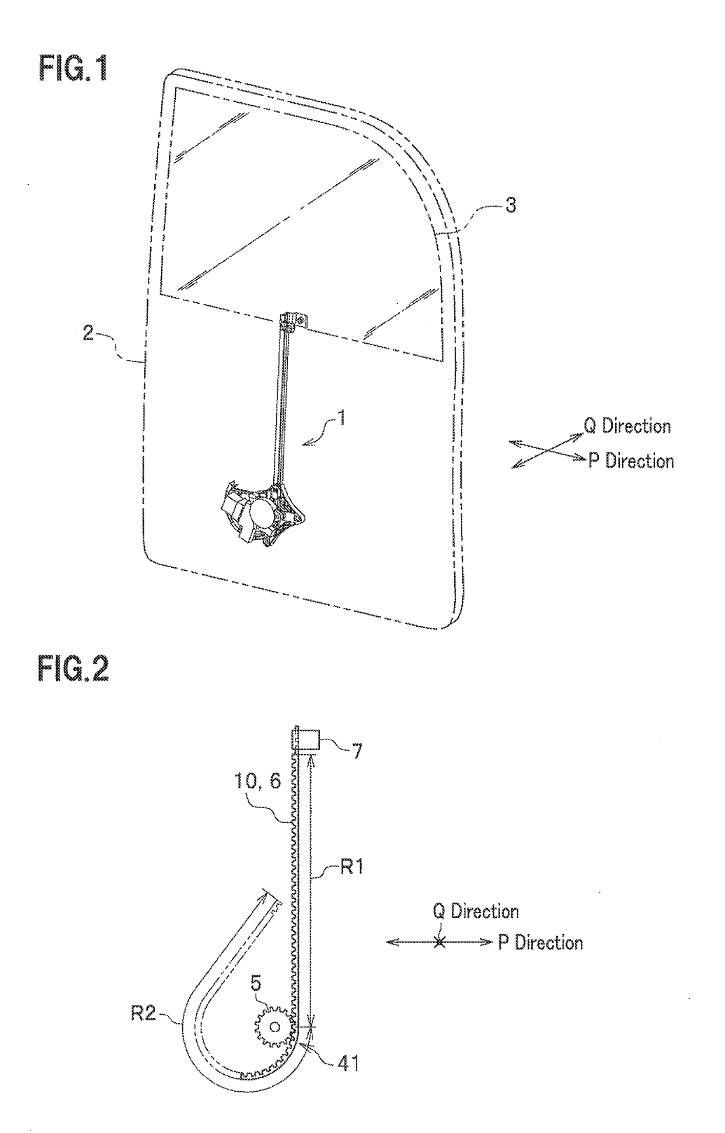

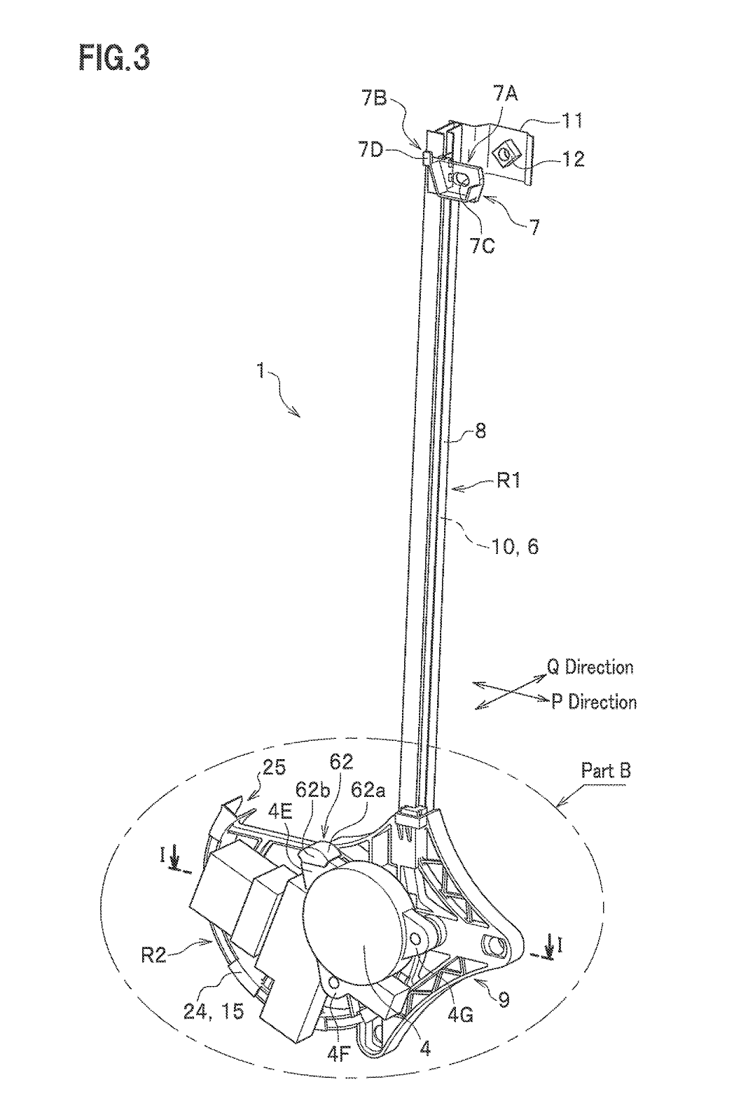

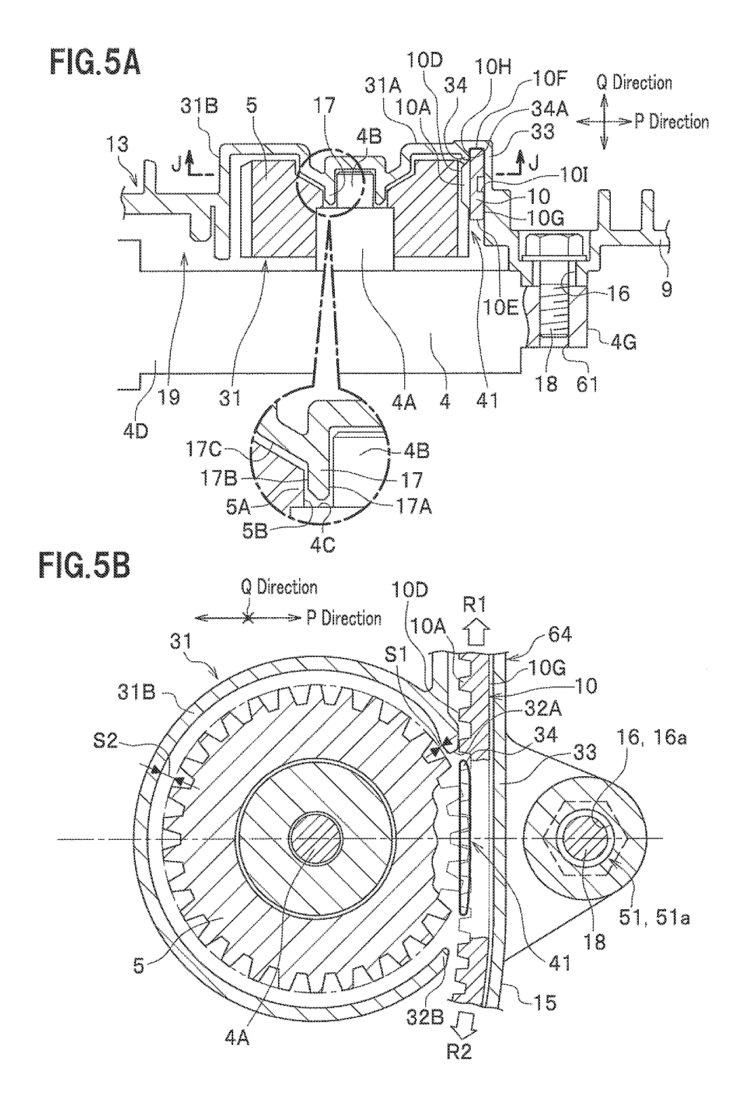

As illustrated in FIG. 1, a window regulator 1 according to the present invention, which moves up and down a pane of window glass 3, is built inside a lower portion of a side door 2 in an automobile. As illustrated in FIG. 3, the window regulator 1 is constituted mainly by a drive motor 4, a drive gear 5, an elongate push-pull member 6, a carrier 7, a guide rail 8, and a frame 9. The drive gear 5 (illustrated in FIGS. 5A and 5B) is axially coupled to the output shaft of the drive motor 4. The elongate push-pull member 6 is open ended, i.e., having one end and the other end, and flexible, meshes with the drive gear 5, and can be pushed and pulled by bidirectional rotations of the drive gear 5. The carrier 7 is connected with the one end of the elongate push-pull member 6 and is also connected with the window glass 3. The guide rail 8 guides the elongate push-pull member 6 and the carrier 7 in a drive path R1. A means for fixing and supporting the drive motor 4, a means for fixing and supporting the guide rail 8, a means for guiding the elongate push-pull member 6 in a curved orbit in an idle path R2, and a means for mounting the window regulator 1 on an object (the side door 2) are integrally formed in the frame 9.

In FIG. 2, the drive path R1 is a path in which the torque of the drive gear 5 converted to an approximately linear motive force for moving the carrier 7 is transmitted to the carrier 7. Specifically, the drive path R1 is a path through which the elongate push-pull member 6 moves, and which extends from the meshing portion 41 at which the drive gear 5 meshes with the elongate push-pull member 6 to a carrier mounting portion at which the carrier 7 is mounted. The idle path R2 is a path provided for retreating the portion of the elongate push-pull member 6 which is not used when the carrier 7 is moved down. When viewed from the Q direction, the drive path R1 is formed in a straight line, and at least a portion of the idle path R2 is formed in a curved shape.

### <Elongate Push-Pull Member 6>

The elongate push-pull member 6 is explained below with reference to FIGS. 2 and 5A and 5B. The elongate push-pull member 6 in the present embodiment is realized by a rack belt 10. The rack belt 10 has a rack-teeth surface 10D, first and second belt side surfaces 10E and 10F, and a belt back surface 10G, where the rack-teeth surface 10D corresponds to the upper surfaces of the rack teeth 10A. Therefore, the drive gear 5 (illustrated in FIGS. 5A and 5B) which meshes with the rack belt 10 is a pinion gear. The rack teeth 10A are formed to have a width smaller than the entire width of the rack belt 10, so that step faces 10H are formed on both sides of the rack teeth 10A. In addition, a rectangular groove 10I is formed in the center in the width direction of the belt back surface 10G, along the direction in which the belt extends.

The rack belt 10 is made of, for example, a synthetic resin. The rack belt 10 is arranged in such a manner that the rack-teeth surface 10D faces the inner side of the curved orbit of the idle path R2.

### <Carrier 7>

As illustrated in FIG. 3, the carrier 7 has a glass connection part 7A and a belt connection part 7B. The glass connection part 7A is formed to have a plate surface along the P direction and connected with a lower portion of the window glass 3 (illustrated in FIG. 1), and the belt connection part 7B is arranged to protrude from a surface of the glass connection part 7A and connected with an end of the rack belt 10. The glass connection part 7A has an approximately rectangular shape which laterally extends when viewed from the Q direction. In addition, a mounting hole 7C through which a bolt (not shown) for fixing the window glass 3 is to be inserted is formed in the glass connection part 7A. Further, a wall 7D for preventing falling down of the window glass 3 is arranged to protrude from another surface of the glass connection part 7A.

An engagement portion in which the rack belt 10 and the carrier 7 are engaged with each other is arranged inside the guide rail 8, and does not come out of the guide rail 8 unless the window regulator 1 is decomposed.

### <Guide Rail 8>

As illustrated in FIG. 3, the guide rail 8 is an elongate member having a fixed cross section and being approximately vertically arranged. In view from the P direction, the guide rail 8 has a gently curved shape corresponding to a curved profile of the window glass 3. In addition, in view from the Q direction, the guide rail 8 has a profile along a straight line. Further, the guide rail 8 includes a rectangular frame portion having a rectangular cross section elongated in the Q direction as illustrated in the plan view so as to guide four sides of the rack belt 10 (the rack-teeth surface 10D, the first belt side surface 10E, the second belt side surface 10F, and the belt back surface 10G). The engagement portion in which the rack belt 10 and the carrier 7 are engaged with each other is laid out in the guide groove for the rack belt 10 in the guide rail 8.

For example, the guide rail 8 is formed by sheet metal working The guide rail 8 is formed by folding back a sheet metal so as to correspond to individual portions. Alternatively, the guide rail 8 may be realized by an extruded part.

As illustrated in FIG. 3, a fixture bracket 11 for fixing the window regulator 1 to the side door 2 is attached to the guide rail 8 by welding or the like. The fixture bracket 11 is formed to have a plate surface approximately along the P direction. Further, in order to fix the window regulator 1 to the side door 2, a nut 12 into which a fastening bolt (not shown) is to be screwed is attached to the fixture bracket 11.

### <Drive Motor 4>

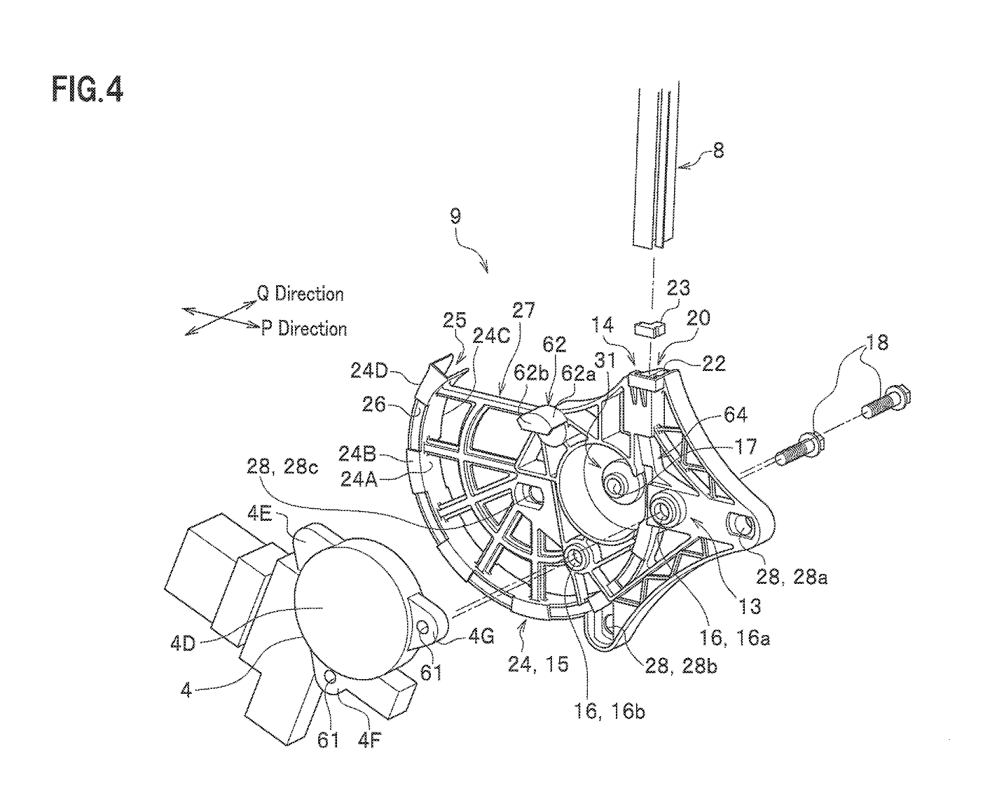

As illustrated in FIGS. 4 and 5A, the drive motor 4 is constituted by an output shaft 4A, a small-diameter portion 4B, a main body part 4D, and protruding parts 4E, 4F and 4G, where the small-diameter portion 4B is continuous with the output shaft 4A. The output shaft 4A is a portion caused to rotate by the drive of the motor (not shown). The small-diameter portion 4B is continuous with the output shaft 4A and has a smaller outer diameter than the outer diameter of the output shaft 4A. The main body part 4D is a portion where the motor is accommodated. The main body part 4D has an approximately circular shape and is coaxial with the output shaft 4A.

The protruding parts 4E, 4F and 4G are portions protruding from the outer circumferential surface of the main body part 4D outward (outward in the radial direction of the output shaft 4A). In the present embodiment, the protruding parts 4E, 4F and 4G are formed equidistantly around the main body part 4D. That is, the protruding parts 4E, 4F and 4G have centers arranged at locations approximating the apexes of an equilateral triangle. The protruding parts 4F and 4G are formed with the threaded holes 61 that correspond to the bolts 18, respectively.

### <Frame 9>

The frame 9 is explained below with reference to FIGS. 4 and 5A and 5B. The frame 9 includes a motor-fixture portion 13 for fixing and supporting the drive motor 4, a guide-rail fixture portion 14 for fixing and supporting the lower end of the guide rail 8, a linear-orbit guide portion 64 for guiding the rack belt 10 in a linear orbit in the drive path R1, a meshing-portion guide wall 33 (illustrated in FIG. 5B), and a curved-orbit guide portion 15 for guiding the rack belt 10 in the curved orbit in the idle path R2. For example, the frame 9 is a resin mold part constituted by the motor-fixture portion 13, the guide-rail fixture portion 14, the linear-orbit guide portion 64, the meshing-portion guide wall 33, and the curved-orbit guide portion 15 which are integrally formed. The linear-orbit guide portion 64, the meshing-portion guide wall 33, and the curved-orbit guide portion 15 constitute the “guide portion” recited in “What is claims”.

### <Motor Fixture Portion 13 (Means for Fixing and Supporting Drive Motor 4)>

The motor-fixture portion 13 is formed as a platelike portion of the frame 9 which is arranged approximately along a plane perpendicular to the Q direction and has multiple protrusions and recesses as illustrated in FIGS. 4 and 5A. The motor-fixture portion 13 has formed therein two motor mounting holes 16, a bearing portion 17, and a positioning regulating portion 62, where the bearing portion 17 has a circular concave shape and rotatably supports a tip end of the output shaft 4A of the drive motor 4.

The positioning regulating portion 62 is constituted by a side wall 62a provided upright on the motor-fixture portion 13 and a cover 62b formed on the side wall 62a. In view from the Q direction, the side wall 62a is curved upward (toward the side opposite to the curved-orbit guide portion 15) in a convex shape. The cover 62b is formed on the top edge of the side wall 62a and covers a portion of the motor-fixture portion 13. The cover 62b has an approximately semi-circular shape in view from the Q direction. The positioning regulating portion 62 is open at the lower portion (toward the curved-orbit guide portion 15). The positioning regulating portion 62 has a height, from the motor-fixture portion 13 to the cover 62b, that is approximately equal to or slightly greater than the thickness of the protruding part 4E.

The motor-fixture portion 13 constitutes a means for fixing and supporting the drive motor 4. The drive motor 4 is fixed to the motor-fixture portion 13 by bolts 18 screwed into the motor mounting holes 16 while the tip end of the output shaft 4A of the drive motor 4 is rotatably supported by the bearing portion 17, with the protruding part 4E in contact with the positioning regulating portion 62. Since the tip end of the output shaft 4A of the drive motor 4 is rotatably supported by the bearing portion 17, inclination of the drive gear 5, which is axially coupled to the output shaft 4A, is prevented, so that the rack teeth 10A of the rack belt 10 precisely mesh with the drive gear 5.

Specifically, the bearing portion 17 is formed as an annular-wall portion protruding toward the drive motor 4. In addition, the tip end of the output shaft 4A is formed to be a small-diameter portion 4B, and an inner surface 17A of the bearing portion 17 rotatably supports the small-diameter portion 4B. In addition, according to the present embodiment, the drive gear 5 is axially coupled to the output shaft 4A by spline coupling or the like in such a manner that the drive gear 5 cannot rotate relative to the drive motor 4 and can slide along the output shaft 4A in the axis direction. A protruded portion 5A is formed on an inner peripheral surface of the drive gear 5, and located between an annular step face 4C of the output shaft 4A and an inclined surface 17C formed on the periphery of the bearing portion 17. Therefore, movement of the drive gear 5 relative to the output shaft 4A in the axis direction is blocked. In addition, an outer peripheral surface 17B of the bearing portion 17 guides an inner peripheral surface 5B of the protruded portion 5A, to have the function of positioning of the drive gear 5 in the radial direction. Although the gap between the inner surface 17A of the bearing portion 17 and the outer peripheral surface of the small-diameter portion 4B and the gap between the outer peripheral surface 17B of the bearing portion 17 and the inner peripheral surface 5B of the drive gear 5 are exaggerated in the illustration in FIG. 5A, the actual gaps are very small.

When the drive motor 4 is fixed to the motor-fixture portion 13, a space around the drive gear 5 becomes an enclosed space 19, which is enclosed by the chassis of the drive motor 4 and a molded surface of the motor-fixture portion 13 as illustrated in FIG. 5A. The enclosed space 19 is formed for the purpose of water tightness, dust tightness, and the like. In addition, in order to further enhance the water tightness, dust tightness, and the like of the enclosed space 19 for the drive gear 5, the drive gear 5 is laid out in a gear-housing space 31 formed in the motor-fixture portion 13. The gear-housing space 31 is formed, along a plane perpendicular to the Q direction, with a base-plate portion 31A and an annular-wall portion 31B. The base-plate portion 31A has an approximately disklike shape with a diameter greater than the diameter of the drive gear 5. The annular-wall portion 31B rises from the base-plate portion 31A toward the drive motor 4 along the Q direction and is annularly formed around the shaft center of the drive gear 5 with a fixed diameter so as to surround the teeth surfaces of the drive gear 5 made of a spur gear. The aforementioned bearing portion 17 is formed in the center of the base-plate portion 31A.

As illustrated in FIG. 5B, an opening is formed in a portion of the annular-wall portion 31B, so that a portion of the drive gear 5 is exposed from the opening in the annular-wall portion 31B and meshes with the rack belt 10. At least, a wall edge 32A, relatively near to the drive path R1, of the both wall edges (32A and 32B) on the opening in the annular-wall portion 31B is formed to protrude toward the shaft center of the drive gear 5. That is, only the wall edge 32A is formed to protrude toward the shaft center of the drive gear 5 from the annular-wall portion 31B, which is centered at the shaft center of the drive gear 5 and has a fixed diameter. Therefore, the gap Si between the wall edge 32A and the teeth surface of the drive gear 5 is set smaller than the gap S2 between the inner peripheral surface of the annular-wall portion 31B and the teeth surface of the drive gear 5. In some cases, the other wall edge 32B of the annular-wall portion 31B on the idle path R2 side of the opening in the annular-wall portion 31B may also be formed to protrude toward the shaft center of the drive gear 5, i.e., the gap between the wall edge 32B and the teeth surface of the drive gear 5 becomes smaller than the gap S2 between the inner peripheral surface of the annular-wall portion 31B and the teeth surface of the drive gear 5.

The reason why the gap S1 between the wall edge 32A and the teeth surface of the drive gear 5 is set smaller than the gap S2 between the inner peripheral surface of the annular-wall portion 31B and the teeth surface of the drive gear 5 is explained below. If the gap S1 is set equal to the gap S2, the rack belt 10 can be caught into the gap between the wall edge 32A and the drive gear 5. Since no great burden is imposed on the portion of the rack belt 10 which is located on the idle path R2 side of the meshing portion 41, almost no excessive bending deformation is likely to occur in the portion of the rack belt 10 located on the idle path R2 side. Therefore, there is almost no possibility that the rack belt 10 is caught into the gap between the drive gear 5 and the wall edge 32B located on the idle path R2 side. On the other hand, since the load caused by ascent and descent of the window glass 3 is imposed on the portion of the rack belt 10 located on the drive path R1 side, excessive bending deformation can occur in the portion of the rack belt 10 located on the drive path R1 side. Therefore, the portion of the rack belt 10 located on the drive path R1 side can be caught into the gap between the drive gear 5 and the wall edge 32A.

In order to overcome the above problem, for example, a technique of making the aforementioned gap S2 small while equalizing the inner diameter of the entire annular-wall portion 31B including the wall edges 32A and 32B may come to mind. However, since the gap S2 to the annular-wall portion 31B is set small in approximately the entire circumference of the drive gear 5 according to the above technique, it is difficult to control the quality of the gap S2 in consideration of errors in fabricating the motor-fixture portion 13 and errors in mounting the drive gear 5. On the other hand, in the case where the gap S2 is set to be a sufficiently large value, and only the gap Si to the wall edge 32A (and the gap to the wall edge 32B in some cases) is set smaller than the gap S2, the target of the quality control can be limited to only one point (or two points in the case where the gap S1 to the wall edge 32B is also set small).

Next, in the meshing portion 41 between the drive gear 5 and the rack belt 10, the belt back surface 10G of the rack belt 10 is guided by the meshing-portion guide wall 33, which is linearly formed along the vertical direction in the motor-fixture portion 13. In addition, as illustrated in FIG. 5A, a meshing-portion guide protrusion 34 is formed on the base-plate portion 31A in parallel with the meshing-portion guide wall 33. The meshing-portion guide protrusion 34 is formed to extend from a vicinity of the wall edge 32A to a vicinity of the wall edge 32B, for example, as illustrated in FIG. 5B, and guides one of the step faces 10H of the rack belt 10 along a planar guide face 34A of the meshing-portion guide protrusion 34 as illustrated in FIG. 5A. Thus, the rack belt 10 is guided by the meshing-portion guide wall 33 and the meshing-portion guide protrusion 34, so that deflection of the rack belt 10 in the belt thickness direction is suppressed and the depth of the mesh between the drive gear 5 and the rack teeth 10A is maintained constant.

### <Connection Portions 51>

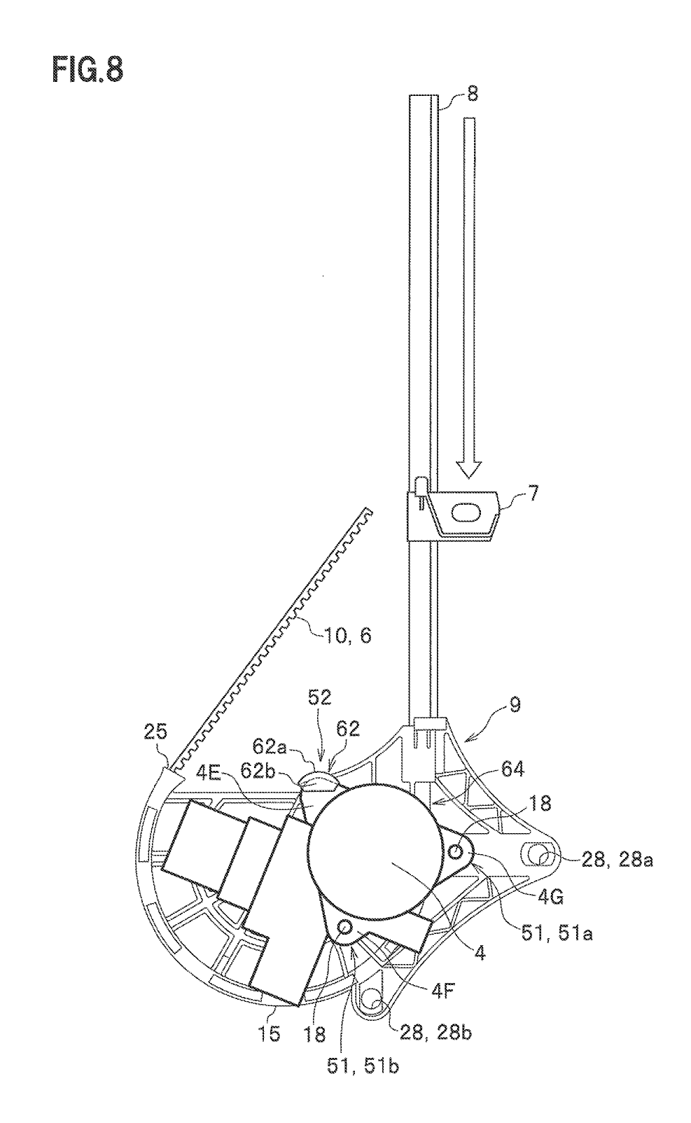

As illustrated in FIG. 4, according to the present embodiment, the positioning regulating portion 62 and the motor mounting holes 16 (16a and 16b) are arranged at three positions in the frame 9 so as to surround the gear-housing space 31. The connection portions 51 (51a and 51b) are realized at the two positions and the contact portion 52 is realized at the one position as illustrated in FIG. 8 by respectively inserting the bolts 18 through the motor mounting holes 16 and fastening the drive motor 4 to the frame 9. The connection portions 51 specifically mean connection points of the drive motor 4 with the frame 9 in the aforementioned means for fixing and supporting the drive motor 4.

Among others, the connection portion 51 a is formed in the vicinity of the meshing portion 41 between the drive gear 5 and the rack belt 10, on the side opposite to the drive gear 5 with respect to the meshing-portion guide wall 33. Specifically, the connection portion 51a is formed in a vicinity of the meshing-portion guide wall 33 on an extension of a line connecting the output shaft 4A and the meshing portion 41 as illustrated in FIG. 5B.

When the drive gear 5 rotates, the rack belt 10 and the meshing-portion guide wall 33 receive a force in the direction away from the drive gear 5 (the direction to the right in FIG. 5B) at all times. Therefore, there is a possibility that the meshing-portion guide wall 33 is inclined by the above force, so that the rack belt 10 can become apart from the drive gear 5 and idling of the drive gear 5 can occur. In particular, the greatest force is applied to the part of the meshing-portion guide wall 33 which is located on the extension of the line connecting the output shaft 4A and the meshing portion 41.

However, it is possible to reinforce the meshing-portion guide wall 33 and prevent inclination of the meshing-portion guide wall 33 by arranging the connection portion 51 a at a position on the extension of the line connecting the output shaft 4A and the meshing portion 41 in the vicinity of the meshing portion 41 on the side opposite to the drive gear 5 with respect to the meshing-portion guide wall 33. Therefore, the rack belt 10 can be suitably guided, so that idling of the drive gear 5 can be prevented. In addition, the provision of the connection portion 51 a enables reduction in the thickness of the meshing-portion guide wall 33 and achievement of both of the fastening of the drive motor 4 to the frame 9 and the reinforcement of the meshing-portion guide wall 33.

Although the connection portion 51a is positioned as explained above according to the present embodiment, the position of the connection portion 51 a is not limited to the position explained above. It is sufficient for the connection portion 51 a to be located in a vicinity of the meshing portion 41 on the side opposite to the drive gear 5 with respect to the meshing-portion guide wall 33.

### <Guide-rail Fixture Portion 14 (Means for Fixing and Supporting Guide Rail 8)>

As in the first embodiment, the guide-rail fixture portion 14 as illustrated in FIG. 4 is located on the upper portion of the motor-fixture portion 13, and is formed to have an opening 20. The opening 20 is a vertical through hole through which the bottom end portion of the guide rail 8 can be inserted for fixing. The linear-orbit guide portion 64 for guiding the rack belt 10 is located in the area between the guide-rail fixture portion 14 and the meshing-portion guide wall 33. The linear-orbit guide portion 64 has one end that is in communication with the opening 20 of the guide-rail fixture portion 14 and the other end that is continuous with the meshing-portion guide wall 33 (illustrated in FIG. 5B).

A stopper fixture portion 22 as illustrated in FIG. 4 is formed above the opening 20 in the frame 9, and a stopper 23 is attached to the stopper fixture portion 22 in such a manner that the stopper 23 is inserted from the upper side of the stopper fixture portion 22. The stopper 23 is, for example, made of a rubber mold part. The stopper 23 limits the downward motion of the carrier 7 by coming into contact with the carrier 7. In addition, the stopper 23 has watertight and dust-tight functions for the enclosed space 19 (illustrated in FIG. 5A) since the stopper 23 covers part of the gaps between the guide rail 8 and the inner walls of the opening 20 from the upper side.

### <Curved-orbit Guide Portion 15 (Means for Guiding Elongate Push-Pull Member 6 in Curved Orbit in Idle Path R2)>

As illustrated in FIG. 4, the curved-orbit guide portion 15 is constituted by a rectangular-pipe member 24 having a rectangular cross-section the long side of which is in the Q direction. The rectangular-pipe member 24 has an inner-peripheral guide wall 24A, a first side guide wall 24B, a second side guide wall 24C, and an outer-peripheral guide wall 24D respectively for guiding the rack-teeth surface 10D, the first belt side surface 10E, the second belt side surface 10F, and the belt back surface 10G of the rack belt 10 (illustrated in FIG. 5) when the rack belt 10 is inserted through the curved-orbit guide portion 15. The curved-orbit guide portion 15 is formed to be curved along a curve which is convex down and has an approximately constant radius of curvature. The curved-orbit guide portion 15 has a tip end which faces the enclosed space 19 (the meshing-portion guide wall 33), and extends from the bottom of the motor-fixture portion 13 to a tail-end opening 25, which faces to an upward direction inclined to the drive path R1 side from the vertical direction. The tail-end opening 25 is located above the meshing portion 41 between the drive gear 5 and the rack belt 10. Perforations 26 for the purpose of weight reduction and the like are formed at appropriate intervals along the direction in which the curved-orbit guide portion 15 extends, in each of the first side guide wall 24B and the second side guide wall 24C. The rectangular-pipe member 24 is connected with the motor-fixture portion 13 through a connection portion 46. When the window glass 3 (illustrated in FIG. 1) is opened to a predetermined degree, i.e., when the carrier 7 moves down to a predetermined position, the other end of the rack belt 10 protrudes out of the tail-end opening 25.

### <Mounting Hole 28 (Means for Mounting on Object)>

As illustrated in FIG. 4, multiple mounting holes 28 are formed around the motor-fixture portion 13 in the frame 9 as a means for mounting on an object (for example, the side door 2) on which the window regulator 1 is to be mounted. The lower portion of the window regulator 1 is fixed to the side door 2 (FIG. 13) by screwing bolts through the mounting holes 28 in the frame 9, and the upper portion of the window regulator 1 is fixed to the side door 2 by screwing the bolt through the fixture bracket 11 (FIG. 3) as described before. As illustrated in FIG. 8, the multiple mounting holes 28 (28a, 28b, and 28c) are arranged at three positions. Among others, the mounting hole 28a is formed on an extension of a line connecting the output shaft 4A of the drive motor 4 and the meshing portion 41 between the drive gear 5 and the rack belt 10.

### <Method of Fixing Drive Motor 4>

A method of fixing the drive motor includes a preparation step, a mounting step, a rotation step and a connection step.

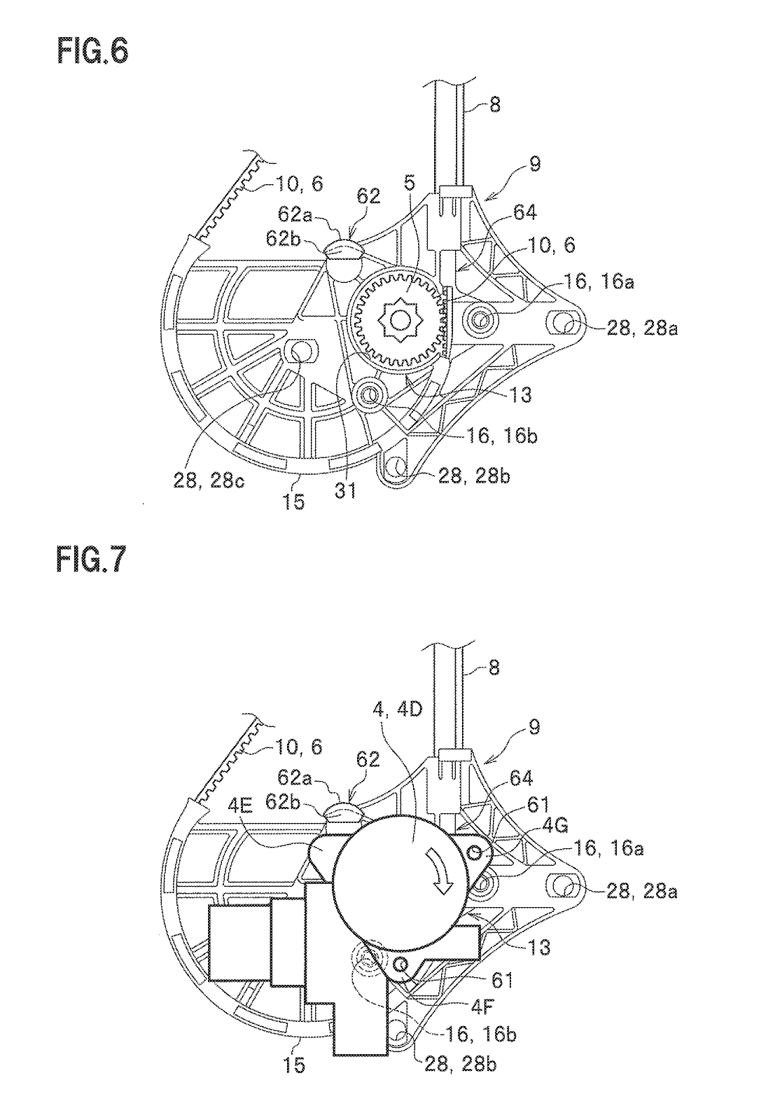

In the preparation step, the drive gear 5 is placed in the gear-housing space 31, and the rack belt 10 is meshed with the drive gear 5 while moving the rack belt 10 through the linear-orbit guide portion 64 and the curved-orbit guide portion 15 of the frame 9, as illustrated in FIG. 6.

Next, in the mounting step, the drive motor 4 is placed on the motor-fixture portion 13, and the output shaft 4A of the drive motor 4 is spline-coupled to the drive gear 5, as illustrated in FIG. 7.

Then, as illustrated in FIG. 7, in the rotation step, the drive motor 4 is rotated on a rotational center of the output shaft 4A (in the present embodiment, clockwise) to bring the protruding part 4E into contact with the side wall 62a of the positioning regulating portion 62. That is, the drive motor 4 is rotated until the protruding part 4E is contained in a space defined by the side wall 62a and the cover 62b. When the protruding part 4E contacts the positioning regulating portion 62, threaded holes 61 communicate with the motor mounting holes 16, respectively.

Lastly, the bolts 18 are inserted into the combinations of the threaded holes 61 and the motor mounting holes 16 to allow the drive motor 4 to be connected with the frame 9, as illustrated in FIG. 8.

In the window regulator 1 according to the present embodiment, the frame 9 includes, as described before, the motor-fixture portion 13 for mounting the drive motor 4, as well as the linear-orbit guide portion 64, the meshing-portion guide wall 33, and the curved-orbit guide portion 15 (guide portions) for guiding the elongate push-pull member 6. Therefore, it is easy to mount the drive motor 4 and the elongate push-pull member 6 onto the frame 9.

In addition, the protruding part 4E of the drive motor 4 is adapted to fit into the positioning regulating portion 62 of the frame 9, which facilitates positioning the drive motor 4 relative to the frame 9 and mounting the drive motor 4 onto the frame 9. Further, since the frame 9 is assembled to make the window regulator 1 in advance, operations to fix the window regulator 1 to the side door 2 are facilitated.

In addition, according to the present embodiment, the positioning regulating portion 62 includes the cover 62b. Accordingly, the protruding part 4E is accommodated within the positioning regulating portion 62 with no clearance or only a slim clearance. As a result, shaking of the drive motor 4 against the motor-fixture portion 13 is suppressed after the rotation step is finished. Further, the side wall 62a which is curved stably accepts the curvature of an outer circumference of the protruding part 4E.

In addition, the protruding part 4E is adapted to fit into the positioning regulating portion 62 without using bolts or the like. As a result, it is possible to reduce the number of operations in mounting the motor 4 onto the frame 9 and save the costs for components.

Although in the present embodiment, the positioning regulating portion 62 is configured as described above, it may be configured otherwise if the rotational motion of the protruding part 4E is prevented. Further, the drive motor 4 may be rotated anticlockwise to be positioned. In addition, a threaded hole may be bored through the protruding part 4E and the frame 9 may be formed with a motor mounting hole corresponding to the threaded hole, so that a bolt can be inserted into the combination of the motor mounting hole and the threaded hole to secure the motor 4 to the frame 9.

According to the present embodiment, two motor mounting holes 16 are provided. However, one or three or more motor mounting holes 16 may be provided. Further, according to the present embodiment, in which the protruding part 4E is adapted to contact the positioning regulating portion 62, there is no limitation as to which part of the drive motor 4 contacts the positioning regulating portion 62 as long as part of the drive motor 4 contacts the positioning regulating portion 62.

### <Operations of Window Regulator>

When the drive motor 4 is driven, the rack belt 10 meshing with the drive gear 5 moves in the drive path R1 straightly in view from the Q direction, and the carrier 7, which is engaged with the top end of the rack belt 10, moves up and down while being guided by the guide rail 8, so that the window glass 3 moves up and down.

In addition, as illustrated in FIG. 5B, in the meshing portion 41, the gap S1 between the wall edge 32A and the teeth surface of the drive gear 5 is set smaller than the gap S2 between the inner peripheral surface of the annular-wall portion 31B and the teeth surface of the drive gear 5. Therefore, the rack belt 10 is not caught into the gap between the wall edge 32A and the drive gear 5. Further, since the rack belt 10 is guided by the meshing-portion guide wall 33 and the meshing-portion guide protrusion 34, deflection of the rack belt 10 in the belt thickness direction is suppressed, and the depth of the mesh between the drive gear 5 and the rack teeth 10A is maintained constant.

The portion of the rack belt 10 which is not used when the carrier 7 is moved down is turned up by the rectangular-pipe member 24 so as to be retreated and housed. When the carrier 7 moves down to a predetermined position, the other end of the rack belt 10 approximately linearly protrudes out of the tail-end opening 25 toward the guide rail 8 as illustrated in FIG. 8.

According to the present invention, in view from the Q direction, that is, from the direction approximately perpendicular to the plate surface of the window glass 3, the drive path R1 is formed linearly in the portion of the elongate push-pull member 6 extending from the meshing portion 41 at which the drive gear 5 meshes with the elongate push-pull member 6 to the carrier mounting portion at which the carrier 7 is mounted. Accordingly, the portion of the elongate push-pull member 6 which is located in the drive path R1 does not include a curved portion. Therefore, no bending stress occurs in the drive path R1, so that force transmission loss caused by the elongate push-pull member 6 is reduced, and the torque of the drive motor 4 is efficiently converted to the linear motive force and is then transmitted.

In view from the Q direction, a portion of the idle path R2 for retreating the portion of the elongate push-pull member 6 which is currently not used, i.e., the portion of the elongate push-pull member 6 extending from the meshing portion 41 to the other end, is formed with the curved-orbit guide portion 15 to have the curved shape. Therefore, the elongate push-pull member 6, which is an elongate member, can be laid out in a limited space such as the side door 2 or the like.

In addition, since the window regulator 1 is configured to let the other end of the elongate push-pull member 6 protrude out of the curved-orbit guide portion 15, it is possible to reduce the region in which the curved-orbit guide portion 15 is arranged, and make the curved-orbit guide portion 15 compact and lightweight.

The window regulator 1 can be configured such that the drive path R1 extends downward from the meshing portion 41 (for example, in the case where the window regulator 1 illustrated in FIG. 15 is arranged upside down). However, in such a case, the drive motor 4 is located on the upper side. Therefore, the center of gravity of the window regulator 1 is elevated, and it is necessary to configure the window regulator 1 in such a manner that no interference with the drive motor 4 occurs in the portion in which the carrier 7 is connected with the window glass 3.

On the other hand, in the case where the drive path R1 is arranged to be directed upward from the meshing portion 41 as in the present embodiment, the drive motor 4 is located in the lower portion of the window regulator 1, and the structure for connecting the carrier 7 with the window glass 3 can be simplified. Therefore, the center of gravity of the window regulator 1 is lowered, so that the window regulator 1 according to the present embodiment is preferable for application to the side door 2, in which the center of gravity is required to be lowered. Further, since the curved-orbit guide portion 15 is formed to be convex down and extend to the position at which the tail-end opening 25 faces to an upward direction inclined to the drive path R1 side from the vertical direction. Therefore, the elongate push-pull member 6 can be turned up, retreated, and housed in a further compact arrangement.

Incidentally, if the window regulator has a structure which is fabricated by mounting on the frame 9 the output shaft 4A of the drive motor 4 to which the drive gear 5 is rigidly fixed in advance, it is necessary to strictly control the precision in the fixing of the drive gear 5 to the drive motor 4 in order to achieve required precision in meshing between the rack teeth 10A and the drive gear 5. On the other hand, according to the present embodiment, the drive gear 5 is axially coupled to the output shaft 4A in such a manner that the drive gear 5 cannot rotate relative to the output shaft 4A and can slide along the axial direction, for example, by using the spline coupling. In this case, it is possible to precisely and easily determine the relative positions between the three parts as the drive gear 5, the drive motor 4, and the rack belt 10, and precisely control the meshing between the drive gear 5 and the rack teeth 10A, by using a structure in which the output shaft 4A of the drive motor 4 is rotatably supported by the bearing portion 17 and the inner peripheral surface 5B of the drive gear 5 is positioned and guided by the outer peripheral surface 17B of the bearing portion 17.

The preferable embodiment of the present invention has been explained above. Although the elongate push-pull member 6 is the rack belt 10 in the above embodiment, another example of the elongate push-pull member 6 is a geared wire which has a spiral groove being formed on the outer peripheral surface and meshing with the drive gear 5. Further, open-ended belts other than the rack belt 10 can also be used as the elongate push-pull member 6. For example, in the case where the drive gear 5 is a toothed pulley, a timing belt having tooth grooves or tooth holes is used as the elongate push-pull member 6.

What is claimed:

1. A method of fixing a drive motor in a window regulator, the window regulator comprising: a drive gear connected with the drive motor; an elongate push-pull member which is open ended, meshes with the drive gear, and is moved by bidirectional rotations of the drive gear to ascend and descend a carrier; and a frame for fixing and supporting the drive motor, the frame including: a guide portion for guiding the movement of the elongate push-pull member; a motor-fixture portion for mounting the drive motor; a motor mounting hole formed in the motor-fixture portion; and a positioning regulating portion formed on the motor-fixture portion for positioning the drive motor,
the method comprising the steps of:
mounting the drive motor onto the motor-fixture portion;
rotating the drive motor with an output shaft as a center of rotation to bring a portion of the drive motor into contact with the positioning regulating portion; and
connecting the frame with the drive motor through the motor mounting hole.

2. A window regulator comprising:
a drive gear connected with a drive motor;
an elongate push-pull member which is open ended, meshes with the drive gear, and is moved by bidirectional rotations of the drive gear to ascend and descend a carrier; and
a frame for fixing and supporting the drive motor,
the frame including:
a guide portion for guiding motion of the elongate push-pull member;
a motor-fixture portion for mounting the drive motor;
a motor mounting hole formed in the motor-fixture portion; and
a positioning regulating portion formed on the motor-fixture portion and contacting a portion of the drive motor,
the positioning regulating portion including a side wall and a cover, the side wall being provided upright on the motor-fixture portion, the cover extending from the side wall and covering a portion of the motor-fixture portion,
the portion of the drive motor entering into a space defined by the side wall and the cover in a circumferential direction of an output shaft of the drive motor.

3. The window regulator of claim 2 wherein a height from the motor-fixture portion to the cover is approximately equal to a thickness of the portion of the drive motor that contacts the positioning regulating portion.
